(19) United States
(12) Patent Application Publication
(10) Pub. No.: US 2020/0358174 A1
(43) Pub. Date: Nov. 12, 2020

(54) MICROCELLULAR FOAM BODY COMPONENT FOR A VEHICLE RADAR SYSTEM AND ITS METHODS OF MANUFACTURE

(71) Applicant: SRG GLOBAL, INC., Troy, MI (US)

(72) Inventor: James Michael SHURISH, Troy, MI (US)

(73) Assignee: SRG Global, Inc., Troy, MI (US)

(21) Appl. No.: 15/733,334

(22) PCT Filed: Dec. 27, 2018
(86) PCT No.: PCT/IB2018/060653

§ 371 Date: Jun. 29, 2020

Related U.S. Application Data
(60) Provisional application No. 62/611,082, filed on Dec. 28, 2017.

(51) Int. Cl. H01Q 1/42; B29C 44/42; B29C 44/34; B29C 45/16; B62D 29/00; B60R 19/52; B60R 13/00

(52) U.S. Cl. CPC H01Q 1/424; B29C 44/42; B29C 44/3446; B29K 2105/041; B62D 29/002; B60R 19/52; B60R 13/00; B29C 45/1679

(57) ABSTRACT

A system for a vehicle comprises a body component of the vehicle that is formed of a microcellular foam and optionally having one or more decorative layers applied thereto and a radar device arranged behind the body component and configured to transmit/receive radar waves therethrough. A method of manufacturing a body component of a vehicle comprises obtaining a molten resin, introducing a gas or a chemical foaming agent into the molten resin to form a microcellular foam, injecting molding the microcellular foam by injecting the microcellular foam into a mold to form the body component, removing the body component from the mold, optionally applying one or more decorative layers to the body component, and arranging the body component in front of a radar device of the vehicle.

### CROSS-REFERENCE TO RELATED APPLICATIONS

This application claims priority to U.S. Provisional Application No. 62/611,082, filed on Dec. 28, 2017. The disclosure of the above applications is incorporated by reference in their entirety.

### FIELD

The present application generally relates to vehicle radar systems and, more particularly, to a microcellular foam body component for a vehicle radar system and its methods of manufacture.

### BACKGROUND

A radar cover or “radome” is a structure or enclosure that protects a radar device (e.g., a radar antenna). For vehicle applications, radar devices can be used for object proximity monitoring, such as in adaptive cruise control systems and other similar systems (e.g., parking assistance systems). For optimal performance of the radar device, the radome should be constructed of material that minimizes attenuation of electromagnetic signals that are transmitted and received by the radar device. For vehicle applications, the radome is often visible (e.g., mounted to an external surface of the vehicle) and therefore it should also be visually appealing. Plastics or resins (polycarbonate, acrylonitrile butadiene styrene, etc.) and metals that are typically used for decoration, however, attenuate the electromagnetic signals. Utilizing a uniform plastic thickness can help mitigate attenuation, but this limits the design of three-dimensional features. Accordingly, while such conventional radomes work well for their intended purpose, there remains a need for improvement in the art.

### SUMMARY

According to one aspect of the present disclosure, a system for a vehicle is presented. In one exemplary implementation, the system comprises a body component of the vehicle that is formed of a microcellular foam, and a radar device arranged behind the body component and configured to transmit/receive radar waves therethrough.

In some implementations, the body component is a radome. In some implementations, the radome consists only of the microcellular foam. In some implementations, the radome consists only of the microcellular foam and one or more decorative layers applied thereto. In some implementations, the one or more decorative layers comprise at least one of a paint, a physical vapor deposition (PVD) metalloid, a film, and a post-transition metal.

In some implementations, the body component is grille bars of a grille assembly of the vehicle. In some implementations, the grille bars consist only of the microcellular foam. In some implementations, the grille bars consist only of the microcellular foam and one or more decorative layers applied thereto. In some implementations, the one or more decorative layers comprise at least one of a paint, a PVD metalloid, a film, and a post-transition metal.

According to another aspect of the present disclosure, a method of manufacturing a body component of a vehicle is presented. In one exemplary implementation, the method comprises obtaining a molten resin, introducing a gas or a chemical foaming agent into the molten resin to form a microcellular foam, injecting molding the microcellular foam by injecting the microcellular foam into a mold to form the body component, removing the body component from the mold, and arranging the body component in front of a radar device of the vehicle.

In some implementations, the method further comprises induction heating within the mold during the injection molding to increase a surface quality of the base component. In some implementations, the body component is a radome. In some implementations, the radome consists only of the microcellular foam. In some implementations, the method further comprises applying one or more decorative layers to the radome, wherein the radome consists of the microcellular foam and one or more decorative layers applied thereto. In some implementations, the one or more decorative layers comprise at least one of a paint, a PVD metalloid, a film, and a post-transition metal. In some implementations, the method comprises applying the film during the injection molding.

In some implementations, the body component is grille bars of a grille assembly of the vehicle. In some implementations, the grille bars consist only of the microcellular foam. In some implementations, the method further comprises applying one or more decorative layers to the grille bars, wherein the grille bars consist of the microcellular foam and the one or more decorative layers applied thereto. In some implementations, the one or more decorative layers comprise at least one of a paint, a PVD metalloid, a film, and a post-transition metal.

Further areas of applicability of the teachings of the present disclosure will become apparent from the detailed description, claims and the drawings provided hereinafter, wherein like reference numerals refer to like features throughout the several views of the drawings. It should be understood that the detailed description, including disclosed embodiments and drawings referenced therein, are merely exemplary in nature intended for purposes of illustration only and are not intended to limit the scope of the present disclosure, its application or uses. Thus, variations that do not depart from the gist of the present disclosure are intended to be within the scope of the present disclosure.

### BRIEF DESCRIPTION OF THE DRAWINGS

FIG. 1 depicts an example vehicle grille assembly according to the principles of the present disclosure;

FIG. 2A illustrates a side view of example microcellular foam radome for a radar system according to the principles of the present disclosure;

FIG. 2B illustrates a side view of a set of example microcellular foam grille bars according to the principles of the present disclosure;

FIG. 2C illustrates a side view of another example microcellular foam radome for a radar system according to the principles of the present disclosure;

FIGS. 3A-3B illustrate plots of example radar or angular loss for conventional plastic and microcellular foam components according to the principles of the present disclosure; and

FIG. 4 illustrates a flow diagram of an example method of manufacturing a microcellular foam body component of a vehicle according to the principles of the present disclosure.

### DETAILED DESCRIPTION

As previously discussed, for optimal performance of a vehicle radar device, a radome should be constructed of material that minimizes attenuation of electromagnetic signals that are transmitted and received by the radar device. Because the radome is visible, it should also be visually appealing. Accordingly, systems and methods of manufacturing are presented for a vehicle radome or grille assembly formed of a microcellular foam. It will be appreciated that other vehicle body components could also be formed of the microcellular foam (e.g., a bumper comprising an integrated retroreflector). The microcellular foam can be designed to provide minimal radar attenuation. In some implementations, the vehicle body components consist only of the microcellular foam, i.e., no other supportive structures or layers. Decorative layers (paint, metalloids, etc.) can also be applied to the microcellular foam components to enhance their visual appeal.

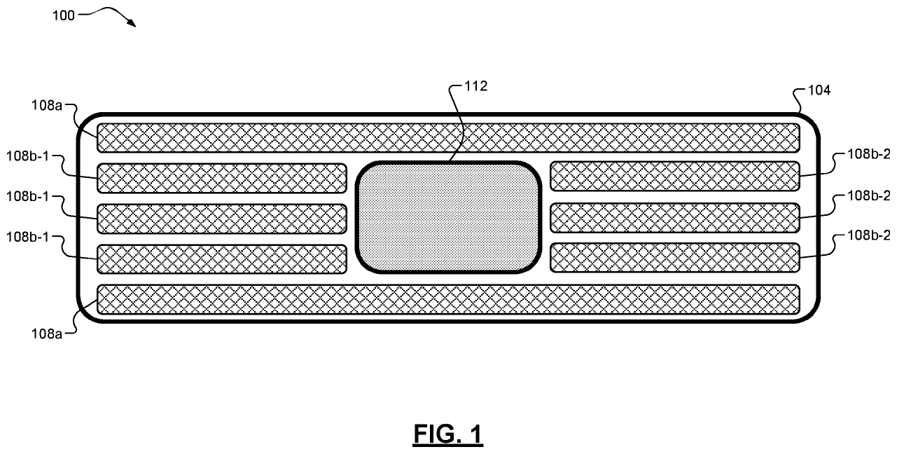

Referring now to FIG. 1, an example grille assembly 100 of a vehicle is illustrated. The grille assembly 100 comprises a housing 104 that includes grille bars 108. These grille bars 108 are divided into different sets: (i) grille bars 108a that span an entire width of the housing 104 and grille bars 108b-1 and 108b-2 that span a portion of the width of the housing 104 and that are disposed on opposing sides of a central radome 112. The radome 112 is arranged in front of a radar device or system (not shown) that transmits/received radar waves. In one exemplary implementation, the radome 112 is designed to display an emblem or logo of the vehicle. As discussed in greater detail below, at least one of the radome 112 and the grille bars 108 could be formed of the microcellular foam.

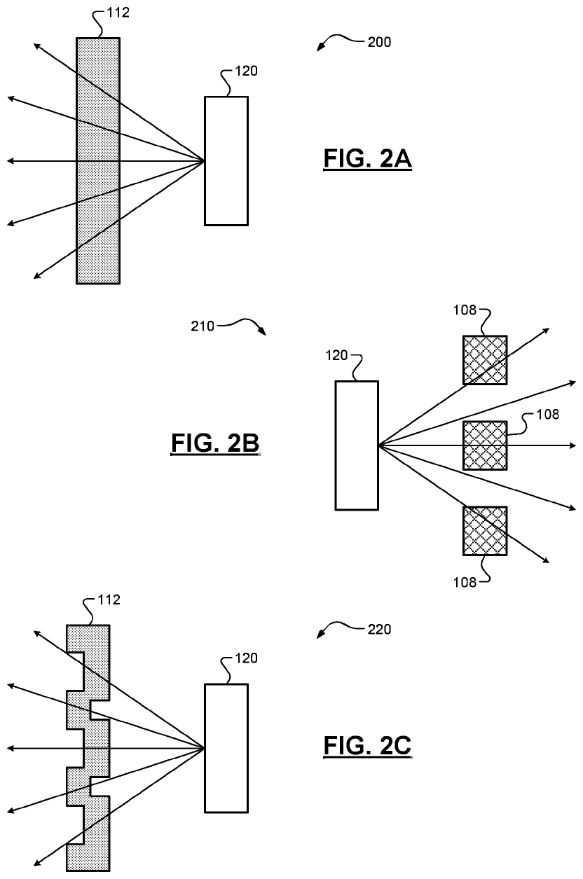

Referring now to FIGS. 2A-2C, side views of a radar system 120 and vehicle body components are illustrated. In FIG. 2A, a side view of the radar system 120 and the radome 112 is illustrated. In this configuration, the radome 112 has a relatively uniform cross-sectional thickness. As shown, radar deflection through the radome 112 is minimal. In FIG. 2B, a side view of the radar system 120 and the grille bars 108 is illustrated. As shown, radar deflection through the grille bars 108 is minimal. In FIG. 2C, a side view of the radar system 120 and an alternate configuration of the radome 112 is illustrated. In this configuration, the radome 112 has a non-uniform cross-sectional thickness because it is designed to have three-dimensional surface features. Nonetheless, as shown, radar deflection through the radome 112 is minimal.

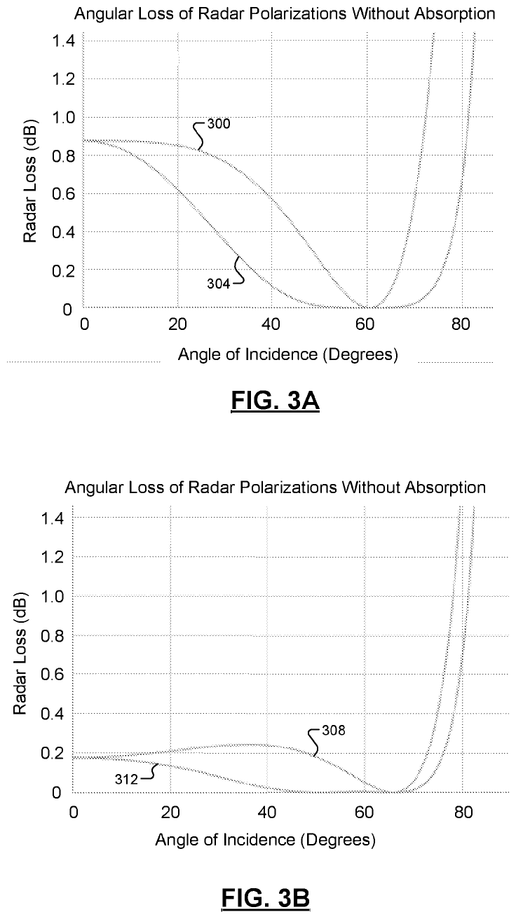

FIGS. 3A-3B illustrate plots of example radar or angular loss for conventional plastic and microcellular foam components. In FIG. 3A, transverse-electric (TE) polarization 300 and transverse-magnetic (TM) polarization 304 are substantial for +/−0-30° angles of incidence for a conventional plastic component. These values decrease from ˜40-60° angles of incidence before reaching Brewster's angle and proceeding to infinite loss. In FIG. 3B, TE polarization 308 and TM polarization 312 are minimal for ˜+/−0-60° angles of incidence before reaching Brewster's angle and proceeding to infinite loss. These plots clearly illustrate the superior performance of a microcellular foam component compared to a conventional plastic component for vehicle radar system-related applications.

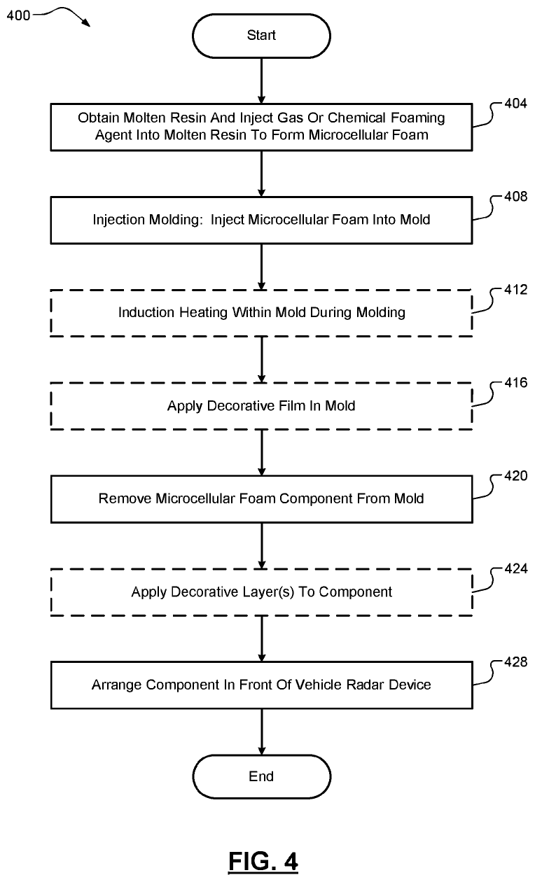

Referring now to FIG. 4, a flow diagram of an example method 400 for manufacturing a microcellular foam vehicle body component is illustrated. At 404, a molten resin is obtained (e.g., by heating the resin) and a gas or a chemical foaming agent is injected into the molten resin to form a microcellular foam. Non-limiting examples of the vehicle body component include a radome and a grille assembly, and non-limiting examples of the resin include polycarbonate (PC) and acrylonitrile butadiene styrene (ABS). One non-limiting exemplary gas is nitrogen. The introduction of this gas or the chemical foaming agent into the molten resin creates air bubbles or pockets in the molten resin. The amount of gas or chemical foaming agent introduced (and thus the size of the air bubbles/pockets) can be determined for each particular vehicle application. For example, ˜1.2 millimeter air bubbles/pockets could be ideal for 24 gigahertz (GHz) radar systems having ˜12 millimeter wavelengths, whereas ˜0.4 millimeter air bubbles/pickets could be ideal for 77 GHz radar systems having ˜4 millimeter wavelengths. It will be appreciated that these values are merely examples and that any suitable size air bubbles/pockets could be utilized as long as they are much smaller than the wavelength of the radar system.

At 408, injection molding is performed wherein the microcellular foam is injected into a mold to form the microcellular foam vehicle body component. At 412, induction heating is optionally performed during the injection molding process. The use of induction heating improves the surface quality of the vehicle body component thereby creating a more visually appealing surface. Absent such induction heating, the surface of the vehicle body component may have white streaks caused by the introduction of the gas during the injection molding process. At 416, a decorative film is optionally applied in the mold. Non-limiting examples of techniques used to apply this film include insert molding and hot stamping. At 420, the vehicle body component is removed from the mold. At 424, decorative layers are optionally applied to the vehicle body component. Non-limiting examples of these decorative layers include paint, a physical vapor deposition (PVD) metalloid, the film, and a post-transition metal. The application of a PVD metalloid on a non-transparent vehicle body component, for example, will make the metalloid appear metallic, but the PVD metalloid will not attenuate radar waves. At 428, the completed vehicle body component is arranged in front of a radar system of a vehicle.

It should be understood that the mixing and matching of features, elements, methodologies and/or functions between various examples may be expressly contemplated herein so that one skilled in the art would appreciate from the present teachings that features, elements and/or functions of one example may be incorporated into another example as appropriate, unless described otherwise above.

What is claimed is:

1. A system for a vehicle, the system comprising:
a body component of the vehicle that is formed of a microcellular foam; and
a radar device arranged behind the body component and configured to transmit/receive radar waves therethrough.

2. The system of claim 1, wherein the body component is a radome.

3. The system of claim 2, wherein the radome consists only of the microcellular foam.

4. The system of claim 2, wherein the radome consists only of the microcellular foam and one or more decorative layers applied thereto.

5. The system of claim 4, wherein the one or more decorative layers comprise at least one of a paint, a physical vapor deposition (PVD) metalloid, a film, and a post-transition metal.

6. The system of claim 1, wherein the body component is grille bars of a grille assembly of the vehicle.

7. The system of claim 6, wherein the grille bars consist only of the microcellular foam.

8. The system of claim 6, wherein the grille bars consist only of the microcellular foam and one or more decorative layers applied thereto.

9. The system of claim 8, wherein the one or more decorative layers comprise at least one of a paint, a physical vapor deposition (PVD) metalloid, a film, and a post-transition metal.

10. A method of manufacturing a body component of a vehicle, the method comprising:
obtaining a molten resin;
introducing a gas or a chemical foaming agent into the molten resin to form a microcellular foam;
injecting molding the microcellular foam by injecting the microcellular foam into a mold to form the body component;
removing the body component from the mold; and
arranging the body component in front of a radar device of the vehicle.

11. The method of claim 10, further comprising induction heating within the mold during the injection molding to increase a surface quality of the base component.

12. The method of claim 10, wherein the body component is a radome.

13. The method of claim 12, wherein the radome consists only of the microcellular foam.

14. The method of claim 12, further comprising applying one or more decorative layers to the radome, wherein the radome consists of the microcellular foam and one or more decorative layers applied thereto.

15. The method of claim 14, wherein the one or more decorative layers comprise at least one of a paint, a physical vapor deposition (PVD) metalloid, a film, and a post-transition metal.

16. The method of claim 15, further comprising applying the film during the injection molding.

17. The method of claim 10, wherein the body component is grille bars of a grille assembly of the vehicle.

18. The method of claim 17, wherein the grille bars consist only of the microcellular foam.

19. The method of claim 17, further comprising applying one or more decorative layers to the grille bars, wherein the grille bars consist of the microcellular foam and the one or more decorative layers applied thereto.

20. The method of claim 19, wherein the one or more decorative layers comprise at least one of a paint, a physical vapor deposition (PVD) metalloid, a film, and a post-transition metal.
